(19) United States
(12) Patent Application Publication
(10) Pub. No.: US 2010/0071197 A1
(43) Pub. Date: Mar. 25, 2010

(54) INTEGRAL ANTENNAS IN METAL LAMINATES

(76) Inventors: Joseph M. Fridy, Pittsburgh, PA (US); Daniel Sarafin, Baden, PA (US); Robert E. Bombalski, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/234,925

(22) Filed: Sep. 22, 2008

(51) Int. Cl. H01P 11/00

(52) U.S. Cl. 29/600

(57) ABSTRACT

A method of making an integral antenna from a metal laminate is provided. The metal laminate comprises a top metal layer, a middle thermoplastic layer, and a bottom metal layer. A portion of the top metal layer of the metal laminate is isolated to create an antenna structure so that the antenna remains a part of the metal laminate to create an integral antenna.

### BACKGROUND OF THE INVENTION

In one embodiment, the present invention relates to a method of making an integral antenna in a metal laminate.

Generally, aluminum enclosures shield their interior from radio frequencies. If radio frequency is required in the interior of the enclosure, the aluminum enclosure may have to be pierced and wired to attached an antenna to the enclosure.

Thus, in one embodiment, the present invention discloses a method of making an integral antenna in a metal laminate.

### SUMMARY OF THE INVENTION

In one embodiment, the present invention provides a method of making an integral antenna by producing a metal laminate. The metal laminate having a top metal layer, a middle thermoplastic layer, and a bottom metal layer where a portion of the top metal layer is isolated to create an antenna structure so that the antenna remains a part of the metal laminate to create an integral antenna.

In another embodiment, the isolating step of the present invention to create the integral antenna is accomplished by milling, slitting the top sheet and stretching the laminate, blanking the top sheet of the laminate, masking the top surface and etching the top sheet of the laminate, water jet machining, laser machining, or by masking the top surface and sand blasting the top sheet.

In a further embodiment, the middle thermoplastic layer is any electrically isolating thermoplastic.

In yet another embodiment, the metal layer has a thickness of about 0.01 inches to about 0.125 inches.

In still another embodiment, the thermoplastic layer has a thickness of about 0.01 inches to about 0.125 inches.

In yet further embodiment, the cured ceramic shell is about 3 microns to about 7 microns in thickness over the coated substrate. In another embodiment, the cured ceramic shell is about 4 microns to about 6 microns in thickness over the coated substrate. The substrate has a paint layer in another embodiment.

Accordingly, it is one embodiment of the invention to provide of making an integral antenna from a metal laminate.

These and other further embodiments of the invention will become more apparent through the following description and drawing.

### BRIEF DESCRIPTION OF THE DRAWINGS

For a fuller understanding of the invention, reference is made to the following description taken in connection with the accompanying drawing(s), in which:

FIG. 1 is a side view of a metal laminate used to produce an integral antenna in accordance with one embodiment of the present invention;

FIG. 2 is a top perspective view of an integral antenna showing one embodiment of the invention; and

FIG. 3 is a side perspective view of the integral antenna of FIG. 1 in accordance with the invention.

### DETAILED DESCRIPTION OF THE PREFERRED EMBODIMENTS

In one embodiment, the present invention discloses a method of making an integral antenna. The method comprises producing a metal laminate. The metal laminate having a top metal layer, a middle thermoplastic layer, and a bottom metal layer. And then isolating a portion of the top metal layer to create an antenna structure so that the antenna remains a part of the metal laminate to create an integral antenna.

The followings are the definitions of the terms used in this application. As used herein, the term “metal laminate” means a multilayer metal structure chemically or mechanically bonded together.

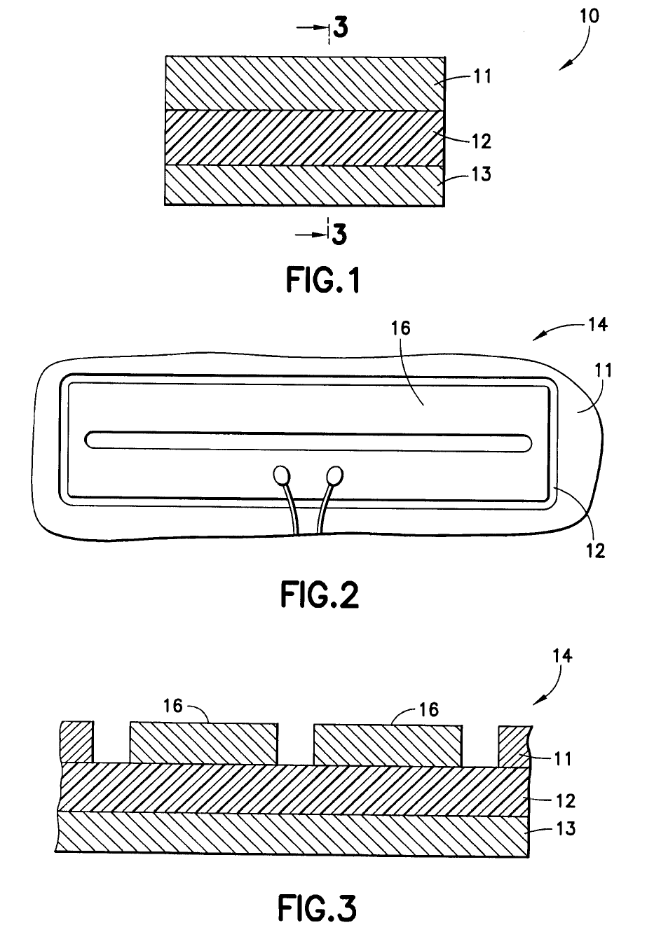

FIG. 1 shows a side view of a metal laminate 10 used to produce an integral antenna 14. Here, metal laminate 10 includes a top metal layer 11, a middle thermoplastic layer 12 and a bottom metal layer 13.

In one embodiment, top metal layer and bottom metal layer are made of aluminum and is a thickness of about 0.01 inches to about 0.125 inches. Types of aluminum alloys that may be used for the top and bottom metal layers in the present invention include, but are not limited to, 1XXX, 2XXX, 3XXX, 4XXX, 5XXX, 6XXX, 7XXX, 8XXX and 9XXX series aluminum alloys (Aluminum Association designations). The top metal layer and the bottom metal layer used may be a different type of aluminum alloy from each other for the metal laminate or they may be the same aluminum alloy for the metal laminate.

In another embodiment, thermoplastic layer is a thickness of about 0.01 inches to about 0.125 inches. In a further embodiment, thermoplastic layer is made of any electrically isolating thermoplastic. Types of thermoplastics that may be used for the middle thermoplastic layer in the present invention include, but are not limited to, polyester, polyethylene and acrylic.

FIG. 2 shows a top view of an integral antenna 14. Part of the top metal layer 11 is isolated to create an antenna structure 16 so that the antenna structure 16 remains a part of metal laminate 10 to create integral antenna 14.

In one embodiment, antenna structure 16 is milled from the top metal layer 11 of metal laminate 10 so that it is isolated from the bottom metal layer 13 by middle thermoplastic layer 12. Antenna structure 16 is still attached to the top metal layer by the adhesion of middle thermoplastic layer 12 of metal laminate 10.

Suitable types of ways that the antenna is created from the top metal layer include, but are not limited to, milling, slitting the top sheet and stretching the laminate, blanking the top sheet of the laminate, masking the top surface and etching the top sheet of the laminate, water jet machining, laser machining, or by masking the top surface and sand blasting the top sheet.

FIG. 3 shows a side view of the integral antenna of FIG. 1 across line 3-3. Here, antenna 16 is created from top metal layer 11 so that the antenna structure 16 remains a part of metal laminate 10 to create integral antenna 14.

### EXAMPLE 1

Two sheets of 3004 aluminum alloy of approximately 2 mm in thickness where powder coated with a polyester and then heated so that the powder coating melts so that both sheets of aluminum are bonded together. The resultant aluminum sheet was machined with a 2 mm end cutter to mill an antenna shape through the top sheet but not through the thermoplastic layer or the bottom sheet. As a result, the antenna was electrically isolated from both the bottom sheet and the rest of the top sheet. Then, an electrical connection was made with an antenna leads to the antenna on the top sheet by capacitance welding a copper wire to the antenna to make the integral antenna.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method of making an integral antenna comprising:
producing a metal laminate comprising:
a top metal layer;
a middle thermoplastic layer; and
a bottom metal layer;
isolating a portion of the top metal layer to create an antenna structure so that the antenna remains a part of the metal laminate to create an integral antenna.

2. The method of claim 1, wherein the isolating a portion of the top metal layer to create an antenna structure is by milling.

3. The method of claim 1, wherein the isolating a portion of the top metal layer to create an antenna structure is by slitting the top sheet and stretching the laminate.

4. The method of claim 1, wherein the isolating a portion of the top metal layer to create an antenna structure is by blanking the top sheet of the laminate.

5. The method of claim 1, wherein the isolating a portion of the top metal layer to create an antenna structure is by masking the top surface and etching the top sheet of the laminate.

6. The method of claim 1, wherein the isolating a portion of the top metal layer to create an antenna structure is by water jet machining.

7. The method of claim 1, wherein the isolating a portion of the top metal layer to create an antenna structure is by laser machining.

8. The method of claim 1, wherein the isolating a portion of the top metal layer to create an antenna structure is by masking the top surface and sand blasting the top sheet.

9. The method of claim 1, wherein the thermoplastic layer is any electrically isolating thermoplastic.

10. The method of claim 1, wherein the metal layer has a thickness of about 0.01 inches to about 0.125 inches.

11. The method of claim 1, wherein the thermoplastic layer has a thickness of about 0.01 inches to about 0.125 inches.

12. The method of claim 1, wherein the top metal layer is a 3XXX series aluminum alloy.

13. The method of claim 12, wherein the bottom metal layer is a 3XXX series aluminum alloy.

14. The method of claim 1, wherein the thermoplastic layer is polyester.

15. The method of claim 1, wherein the thermoplastic layer is polyethylene.

16. The method of claim 1, wherein the thermoplastic layer is acrylic.
